(19) United States
(12) Patent Application Publication
(10) Pub. No.: US 2006/0139171 A1
(43) Pub. Date: Jun. 29, 2006

(54) Method for reactivation of magnetic detection tag and machine for reactivation of magnetic detection tag

(75) Inventors: Yuichi Iwakata, Saitama (JP); Tetsuo Moroya, Saitama (JP); Kunihiko Matsui, Miyazaki (JP)

Correspondence Address: Norris, McLaughlin & Marcus P.A., 18th Floor, 875 Third Avenue, New York, NY, 10022, US

(73) Assignees: Lintec Corporation, Tokyo (JP); CDN Corporation, Miyazaki (JP)

(21) Appl. No.: 11/299,540

(22) Filed: Dec. 12, 2005

(30) Foreign Application Priority Data
Dec. 13, 2004 (JP) 2004-359344
Oct. 5, 2005 (JP) 2005-292839

(51) Int. Cl. G08B 13/14

(52) U.S. Cl. 340/572.3; 340/572.6

(57) ABSTRACT

The present invention discloses a method for reactivating a magnetic detection tag, which comprises exposing a magnetic detection tag having a soft magnetic substance layer and a hard magnetic substance layer, to an alternating magnetic field generated by applying an AC power to a coil, moving, in this state, either or both of the magnetic detection tag and the alternating magnetic field, thereby sweeping the magnetic detection tag in the alternating magnetic field to demagnetize the magnetized hard magnetic substance layer of the magnetic detection tag; and a machine for reactivating a magnetic detection tag.

### TECHNICAL FIELD

The present invention relates to a method for reactivating a magnetic detection tag to be detected by the use of a magnetic field, as well as to a machine for reactivating a magnetic detection tag. More particularly, the present invention relates to a method for reactivating a magnetic detection tag, which comprises demagnetize a magnetic detection tag which has been magnetized, in an alternating magnetic field to reactivate the magnetic detection tag, as well as to a machine for reactivating a magnetic detection tag, used for the above reactivation method.

### BACKGROUND ART

Magnetic detection tags adhered to goods, etc. and circulated in the market are known (Claim 1 of JP 1994-342065 A). These magnetic detection tags use a magnetic field as a detection means. The magnetic detection tags are carried together with the goods and, when passing through particular gates, are detected by the gates; thereby, the circulation of goods is controlled and the theft of goods is prevented.

FIG. 4 shows an example of conventional magnetic detection tag. In FIG. 4, 40 is a soft magnetic substance layer containing cobalt, etc. On one side of the soft magnetic substance layer 40 is laminated, via a polyester-based adhesive layer 42, a hard magnetic substance layer 45 having a large number of through-holes 43 formed therein. The hard magnetic substance layer 45 contains a hard magnetic substance element(s) such as nickel or (and) the like. On the upper side of the hard magnetic substance layer 45 is adhered a protective layer 47 made of wood-free paper or a resin film.

On the other side of the soft magnetic substance layer 40 is adhered a release liner 49 via a pressure-sensitive adhesive layer 48. In using this magnetic detection tag, the release liner 49 is released and the release liner-removed tag is adhered to goods or the like to be controlled.

FIG. 5 shows gates 50 and 52 which detect a magnetic detection tag. An alternating magnetic field Y is formed between the gates 50 and 52. To the gates 50 and 52 is fitted a detector (not shown) for detecting a magnetic field intensity, and the detector detects a magnetic field intensity between the gates 50 and 52. Incidentally, 54 is a magnetic detection tag. When the magnetic detection tag 54 moves between the gates 50 and 52 to a direction indicated by an arrow X, in a state fitted to goods, etc. (not shown), the alternating magnetic field Y formed between the gates 50 and 52 is distorted. By detecting this distortion of the alternating magnetic field Y, the passing of the magnetic detection tag 54 between the gates 50 and 52 is detected.

FIG. 6 shows a method for specifically detecting the distortion of magnetic field. In FIG. 6, (a1) shows the waveform of an alternating magnetic field of particular frequency formed between the gates 50 and 52. By converting the axis t of time into an axis f of frequency using a simple mathematical means, a waveform shown in (a2) is obtained.

In FIG. 6, (b1) shows the waveform of an alternating magnetic field which has been distorted by the passing of magnetic detection tag 54 between the gates 50 and 52. By subjecting this distorted waveform to the same axis conversion as above, a waveform shown in (b2) is obtained. In the waveform of (b2), there are seen higher harmonics 60 and 62 caused by the distortion of the alternating magnetic field. By detecting these higher harmonics, the passing of magnetic detection tag 54 between the gates 50 and 52 can be confirmed.

For example, when goods or the like purchased normally is in a state that it can be carried out from a shop, the magnetic detection tag 54 adhered to the good or the like is deactivated. Owing to this deactivation operation, there occurs no distortion of magnetic field when the magnetic detection tag 54 adhered to the goods or the like is passed between the gates 50 and 52. Consequently, the magnetic detection tag 54 adhered to the goods or the like is not detected during the passing between the gates and the goods or the like is carried outside.

Meanwhile, when the goods or the like is carried out illegally, the magnetic detection tag 54 adhered thereto is in a state not deactivated. Therefore, when the goods or the like adhering the magnetic detection tag 54 not deactivated is passed between the gates 50 and 52, a distorted magnetic field is formed. This distorted magnetic field can detect illegal take-out.

Deactivation can be conducted by magnetizing the hard magnetic substance layer 45 of magnetic detection tag shown in FIG. 4, using a deactivation machine.

FIG. 7 shows a deactivation machine used conventionally. This deactivation machine 70 comprises a support 72 and disk-like permanent magnets of 12 mm in diameter, arranged at intervals of about 10 mm. The permanent magnets are arranged so that an N pole 74 and a S pole 76 appear alternately.

When the magnetic detection tag 54 shown in FIG. 4 touches on the upper surface of the deactivation machine 70, the hard magnetic substance layer 45 is magnetized and thereby the magnetic detection tag 54 is deactivated.

The above magnetic detection tag is used in two ways depending upon how it is used; that is, it is finished in a deactivated state, or is reactivated and reused. For example, electric appliances such as TV and the like are purchased at shops ordinarily, are carried home, and used there. A magnetic detection tag adhered to such a product need not be recovered. In such a case, the magnetic detection tag need not be reactivated.

Meanwhile, there is a case that a magnetic detection tag is adhered to rental goods (e.g. rental video) or books of library. In this case, the magnetic detection tag adhered thereto is reactivated every time when the rented goods or books are returned to a rental shop or a library. That is, the magnetic detection tag is returned to a state that it can be detected at gates.

Reactivation of magnetic detection tag is carried out by converting the magnetic property of the hard magnetic substance layer of magnetic detection tag from a magnetized state to a demagnetized state.

There was proposed, as a method for reactivation of magnetic detection tag, a method which uses a magnet array wherein a large number of magnets are arranged so that a magnetic field formed in an exponential envelope, and weaken the magnetic field at every inversion of magnetic pole (Claim 1 of Japanese Patent Application Kohyo No. 2002-527837). Demagnetization of magnetic detection tag is carried out by moving the magnetic detection tag along the surface of the magnet array. In this method, however, the reactivation machine is complicated in structure.

As a commercial reactivation machine, there is a machine wherein a permanent magnet array comprising a large number of permanent magnets arranged in parallel so that an N pole and a S pole appear alternately, is rotated by a battery-driven motor. In this reactivation machine, an alternating magnetic field is generated by rotating the permanent magnet array and, in this alternating magnetic field, a magnetic detection tag is swept. This reactivation machine is a handy type [a reactivation machine produced by LINTEC Corporation, EL-R 01 (trade name)].

This reactivation machine has a sufficient reactivation ability. However, the machine has, for example, a driving section for rotating a magnet array; therefore, it is complicated mechanically and, further, malfunction may occur at the driving section. When the driving section for rotating a magnet array causes malfunction and the rotation of magnets stops, the permanent magnets in the reactivation machine magnetize the hard magnetic substance layer of magnetic detection tag. As a result, the magnetic detection tag is not reactivated and deactivated.

### DISCLOSURE OF THE INVENTION

The present inventors made a study in order to solve the above-mentioned problems. In the study, the present inventors found that a magnetic detection tag can be easily reactivated by using an alternating magnetic field generated by supplying an AC power to a coil, for demagnetization of the magnetic detection tag. A reactivation machine employing this principle requires no moving section and accordingly is low in malfunction, and can desirably generate an alternating magnetic field most appropriate for reactivation, using a simple electronic circuit. The present invention has been completed based on the above finding.

Therefore, the present invention aims at providing a method for reactivating a magnetic detection tag which solves the above-mentioned problems and which can reactivate a magnetic detection tag reliably using a simple machine, and a machine for reactivating a magnetic detection tag.

The present invention is as described below.

[1] A method for reactivating a magnetic detection tag, which comprises exposing a magnetic detection tag having a soft magnetic substance layer and a hard magnetic substance layer, to an alternating magnetic field generated by applying an AC power to a coil, moving, in this state, either or both of the magnetic detection tag and the alternating magnetic field, thereby sweeping the magnetic detection tag in the alternating magnetic field to demagnetize the magnetized hard magnetic substance layer of the magnetic detection tag.

[2] The method for reactivating a magnetic detection tag according to [1], wherein the AC power has a frequency of 100 to 10,000 Hz.

[3] The method for reactivating a magnetic detection tag according to [1], wherein the alternating magnetic field has an intensity of 0.01 T or more.

[4] The method for reactivating a magnetic detection tag according to [1], wherein the magnetic detection tag is swept in the alternating magnetic field at a speed of 5 m/s or less.

[5] A machine for reactivating a magnetic detection tag having a soft magnetic substance layer and a hard magnetic substance layer, which comprises an AC power source and a coil which is connected to the AC power source and generates an alternating magnetic field when an AC power is supplied from the AC power source.

[6] The machine for reactivating a magnetic detection tag according to [5], wherein the coil comprises a core made of a cylindrical dielectric, having at least one gap parallel to the axial direction of core and a conductor wound on the core surface along the section of core parallel to the axial direction of core.

[7] The machine for reactivating a magnetic detection tag according to [5], wherein the coil comprises

a core formed by folding a dielectric at its middle portion of lengthwise direction so that the two ends of dielectric face each other, forming, at the two ends, projections apart from each other by a given distance and projecting in a direction opposite from the middle portion, thereby forming a gap between the projections, and

a conductor wound on the core surface in the width direction of core.

[8] The machine for reactivating a magnetic detection tag according to [6] or [7], wherein the gap has a width of 0.1 to 20 mm.

[9] The machine for reactivating a magnetic detection tag according to [6] or [7], wherein the AC power has a frequency of 100 to 10,000 Hz.

In the present method for reactivation of magnetic detection tag, an alternating magnetic field is generated by using an AC power; therefore, the intensity and frequency of the magnetic field generated can be varied desirably and the optimum conditions for reactivation of magnetic detection tag can be set easily. Particularly when an AC power of high frequency is used (an alternating magnetic field of high frequency can be obtained), more reliable reactivation of magnetic detection tag becomes possible. However, there is a limit when an alternating magnetic field of high frequency is formed by using a conventional permanent magnet array. Further, the present machine for reactivation of magnetic detection tag has no moving portion and accordingly is low in malfunction and simple in structure. Furthermore, when the present machine for reactivation of magnetic detection tag is constituted so that the vicinity of the gap of core of coil projects outwardly from the core and when a magnetic detection tag is reactivated, the tag can be swept reliably in the alternating magnetic field generated by the machine.

### BRIEF DESCRIPTION OF THE DRAWINGS

FIG. 1 is a view showing a constitution of the present invention machine for reactivation of magnetic detection tag.

FIG. 2 is a view showing an example wherein the present invention machine for reactivation of magnetic detection tag is used.

FIG. 3 is a view showing the constitution of a magnetic property tester used for evaluation of the reactivation condition of magnetic detection tag.

FIG. 4 is a sectional view showing an example of the constitution of magnetic detection tag.

FIG. 5 is a view showing a method for detection of magnetic detection tag.

FIG. 6 is a view showing the principle of detection of magnetic detection tag. (a) shows the waveform of an alternating magnetic field generated between gates, and (b) shows the waveform of an alternating magnetic field when a magnetic detection tag has been detected.

FIG. 7 is a plan view showing an example of the constitution of conventional deactivation machine.

FIG. 8 shows other example of the constitution of the coil used in the present invention machine for reactivation of magnetic detection tag. (A) is a side view and (B) is a plan view.

FIG. 9 is a side view showing other example of the core used in the present invention machine for reactivation of magnetic detection tag.

FIG. 10 shows the shape of the core used in Example 3. (A) is a side view and (B) is a plan view.

In these figures, 100 is a machine for reactivation; 2 and 94 are each a core; 4 and 85 are each a gap; 6 is an outer wall surface; 8 is an inner wall surface; P is a width; 10 and 90 are each a conductor; 110, 120, 92a and 92b are each a coil; 12 is an AC power source; 16 is a product to which a tag is to be adhered; 18, 34 and 54 are each a magnetic detection tag.

Q and X are each an arrow; 20 is an alternating magnetic field; R is a distance; 30 is a measurement coil; 32 is an AC power source; 36 is a voltage tester; 40 is a soft magnetic substance layer; 42 is an adhesive layer; 43 is a through-hole; 45 is a hard magnetic substance layer; 47 is a protective layer; 48 is a pressure-sensitive adhesive layer; 49 is a release liner; 50 and 52 are each a gate; Y is an alternating magnetic field; 60 and 62 are each a higher harmonic; and 70 is a deactivation machine.

72 is a support; 74 is an N pole; 76 is a S pole; 82 is a core main body; 82a is a middle portion; 84a and 84b are each a core plate; 86a and 86b are each a bent portion; 88a and 88b are each a front end; 94a and 94b are each a projection; r is a thickness of core; s is a width of core end; l is a distance between the ends of U-shaped core.

### BEST MODE FOR CARRYING OUT THE INVENTION

An embodiment of the present invention is described in detail below with reference to the accompanying drawings.

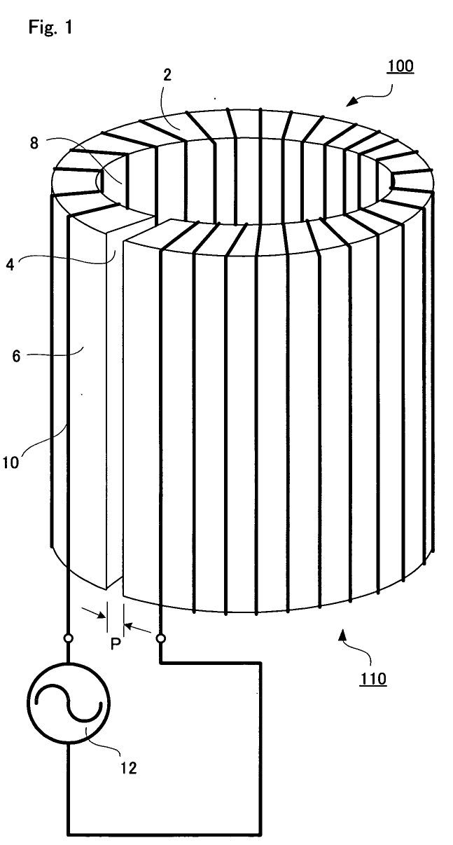

In FIG. 1, 100 is an example of the present invention machine for reactivating a magnetic detection tag. 2 is an approximately cylindrical cores wherein a gap 4 is formed from the outer wall surface 6 of the core 2 to the inner wall surface 8 so as to extend in the axial direction of the core 2. As the material of the core 2, there can be used, with no restriction, a material of high permeability such as ferrite, Permalloy, Sendust, amorphous metal or the like. These materials may be used in combination of two or more kinds. As described later, there is no particular restriction as to the width P of the gap 4 as long as a magnetic detection tag is demagnetized sufficiently by a leaking magnetic field formed in the vicinity of the gap 4. Ordinarily, the width P is preferably about 0.1 to 20 mm, more preferably 0.5 to 15 mm.

A conductor 10 is round the core 2 on the surface along the periphery of the section of the core parallel to the axial direction of the core. The core 2 and the conductor 10 constitute a coil 110.

The two ends of the conductor 10 are connected to an AC power source 12. As to the waveform of an AC power supplied from the AC power source 12, there is no particular restriction, and there can be employed a desired AC waveform such as sine wave, rectangular wave, triangular wave or the like.

The frequency of the AC power is preferably 100 Hz or more, more preferably 300 Hz or more, further preferably 500 to 10,000 Hz.

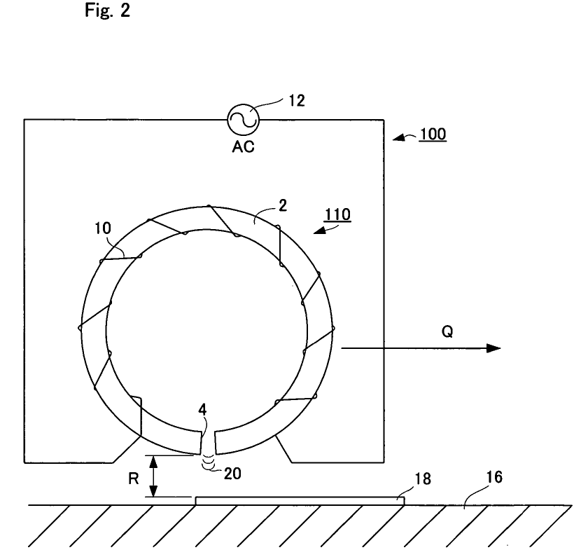

FIG. 2 shows a case in which a magnetic detection tag 18 adhered to a product 16 is reactivated using the reactivation machine 100 shown in FIG. 1. To the product 16 to be controlled, such as commodity, book of library, or the like is adhered a known magnetic detection tag 18 wherein a soft magnetic substance layer (not shown) and a hard magnetic substance layer (not shown) are laminated. The hard magnetic substance layer of this magnetic detection tag 18 is in a stage magnetized (deactivated) by a deactivation machine.

In this state, the gap 4 of the reactivation machine 100 is allowed to face the magnetic detection tag 18, and the reactivation machine 100 is swept in the surface direction of the magnetic detection tag 18 (in FIG. 2, is swept in the direction of an arrow Q).

By this operation, the individual portions of the magnetic detection tag 18 are exposed to an alternating magnetic field 20 leaking out from the gap 4 of the reactivation machine 100, in order along the direction of sweeping. As a result, the magnetized hard magnetic substance layer (not shown) is demagnetized; that is, the magnetic detection tag 18 is reactivated.

The distance R between the magnetic detection tag 18 and the gap 4 is related to the intensity of the leaking alternating magnetic field 20. However, in this case, the R is preferred to be 0.5 to 3 mm for an operational reason.

The intensity of the alternating magnetic field to which the magnetic detection tag 18 is exposed, is related also to the speed of sweeping. Ordinarily, the intensity is preferably 0.01 T or more, more preferably 0.05 to 1.0 T. When the intensity is less than 0.01 T, the reactivation of detection tag may become unreliable.

The speed of sweeping is preferably 5 m/s or less.

The speed of sweeping is related to the frequency of the leaking alternating magnet field 20. When the reactivation machine 100 is swept manually as done ordinarily, the frequency of the alternating magnet field is set at 300 Hz or more, whereby the detection tag can be reactivated reliably. Incidentally, the speed of manual sweeping is ordinarily 3 m/s or less.

In the above reactivation machine 100, there was used, as the core 2, an approximately cylindrical core formed in one piece. However, the core 2 need not be restricted thereto and may be divided in two or more portions in a direction parallel to the cylindrical axis. In this case, it is possible that a conductor is wound round each divided core to produce a plurality of coils and then these coils are combined in an approximately cylindrical shape. With this approach, a reactivation machine can be produced efficiently.

In the above reactivating operation, the reactivation machine 100 was swept. Instead, however, the magnetic detection tag 18 or the product 16 to which the magnetic detection tag 18 has been adhered, may be swept. Or, sweeping may be conducted by moving the magnetic detection tag 18 and the reactivation machine 100 to different directions at the same time.

In the above description, the magnetic detection tag 18 was adhered to the product 16. However, the tag 18 may be fitted to the product 16 using a string or the like, or may be suspended from the product 16.

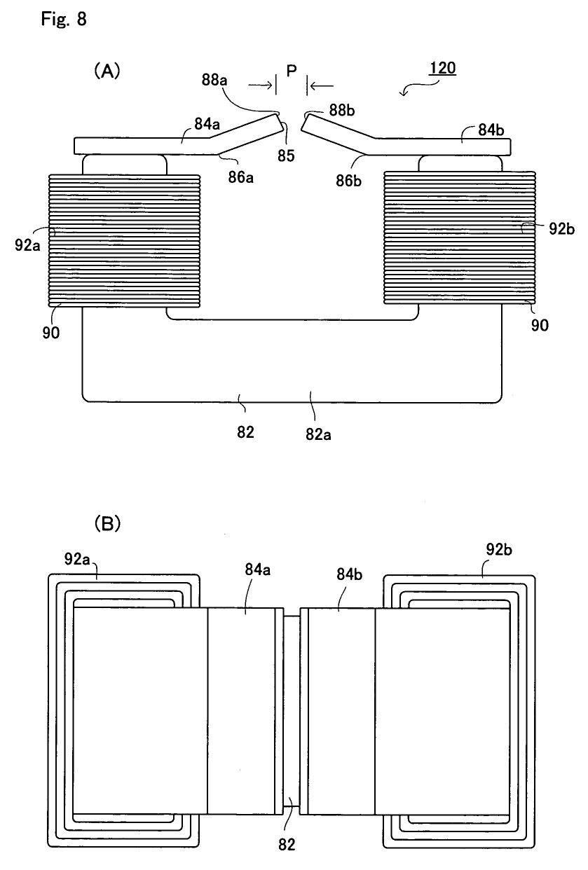

FIG. 8 shows other example of the coil used in the present invention. FIG. 8(A) is a side view and FIG. 8(B) is a plan view.

In this example, 120 is a coil. A core main body 82 is made of a material of high permeability (this material is hereinafter referred to as permeability material). The core main body 82 is bent at its middle portion 82a of the lengthwise direction of the core main body 82 and is formed approximately in a U shape. To the two ends of the core main body 82 are adhered, by an adhesive or the like, core plates 84a and 84b each made of a permeability material, with a given distance taken between them. This distance between the core plates 84a and 84b forms a gap 85. Incidentally, P is the width of the gap.

The core plates 84a and 84b have an approximately rectangular shape and are bent at bending portions 86a and 86b (which are parallel to one side of the rectangular shape) at a given angle. As a result, the front ends 88a and 88b of the core plates 84a and 84b are projected in a direction opposite from the middle portion 82a of the core main body 82, that is, outwardly from the middle portion 82a.

At each of the two arm portions of the U-shaped core main body 82, a conductor 90 (which is a good conductor) is wound by given turns along the surface of the core main body 82 approximately in parallel to the width direction of the core main body 82, whereby coils 92a and 92b are formed. Incidentally, the coils 92a and 92b are connected in series.

As described above, the front ends 88a and 88b of the core plates 84a and 84b of the coil 120 are projected outwardly from the coil 120. Consequently, when a magnetic detection tag is reactivated using a reactivation machine comprising this coil, sweeping can be made easily in a state that the front ends 88a and 88b of the core plates 84a and 84b have been positioned close to the tag. As a result, the reactivation of the tag becomes more reliable.

The core plates 84a and 84b and the core main body 82 are produced separately and they are adhered. They are different parts of different structures. However, they are each made of a permeability material. Therefore, this core is equivalent in electromagnetic property to a core produced in one piece with a permeability material and has the same function as the core produced in one piece.

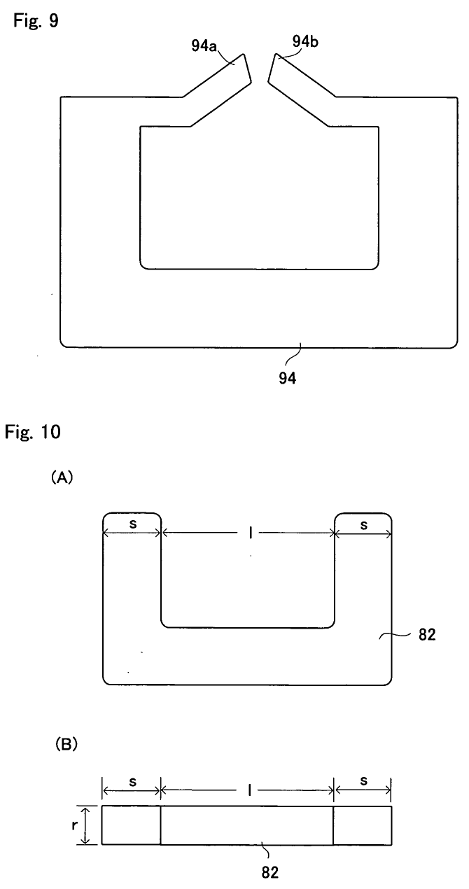

FIG. 9 shows still other core. In this core 94, the two front ends are allowed to face each other and, at the front ends, projections 94a and 94b projecting outwardly are formed integrally with the other portions of the core 94. In the core 94 shown in FIG. 9, unlike in the core shown in FIG. 8, there is no core plate 84a or 84b adhering to the core main body 82. However, the core of FIG. 8 and the core of FIG. 9 are equivalent electromagnetically.

In the present invention, there may be modifications other than described above, as long as there is no deviation from the gist of the present invention.

### EXAMPLES

The present invention is described more specifically below by way of Examples.

### Example 1

There were prepared two half-cylindrical ferrite cores obtained by dividing a cylindrical ferrite core of 25 mm in outer diameter, 12 mm in inner diameter and 30 mm in height, into two parts along a plane including the axial line of the core. A conductor of 0.35 mm in diameter was wound round each half-cylindrical ferrite core 100 times, to produce two coils. The two coils were combined in a cylindrical shape. In this case, at one contact portion of the two half-cylindrical ferrite cores, the divided end surfaces of the half-cylindrical ferrite cores were allowed to be apart from each other by 1 mm (a width P) to constitute a gap 4. At other contact portion, the two half-cylindrical ferrite cores were adhered to each other.

The conductors of the two coils were connected in series and the two ends of the connected conductor were connected to an AC power source. As a result, there was produced a reactivation machine having approximately the same structure as the reactivation machine of FIG. 1 had. In FIG. 1, however, the other contact portion is not shown.

As the AC power source, there was used RC Oscillator 4188 produced by KIKUSUI Electronics Corp. Thereto was connected Stereo Power Amp P 370 produced by Accuphase Laboratory, Inc., whereby the power supplied from the AC power source was amplified. The amplified AC power was supplied to the above coil.

Reactivation Test 1

There were prepared 4 magnetic detection tags (trade name: EP-D 01) produced by LINTEC Corporation, wherein a soft magnetic substance layer and a hard magnetic substance layer were laminated. These detection tags were deactivated (magnetized) using a deactivation machine (trade name: EL-D 01, produced by LINTC Corporation). Using the reactivation machine produced in Example 1, the surfaces of the deactivated magnetic detection tags were swept (see FIG. 2).

The frequency of the alternating magnetic field used was 500 Hz or 1 kHz. The current was fixed at 0.5 A. The speed of sweeping was 3 m/s. During the sweeping, the distance R between each magnetic detection tag surface and the gap 4 of the reactivation machine was maintained at 1 mm.

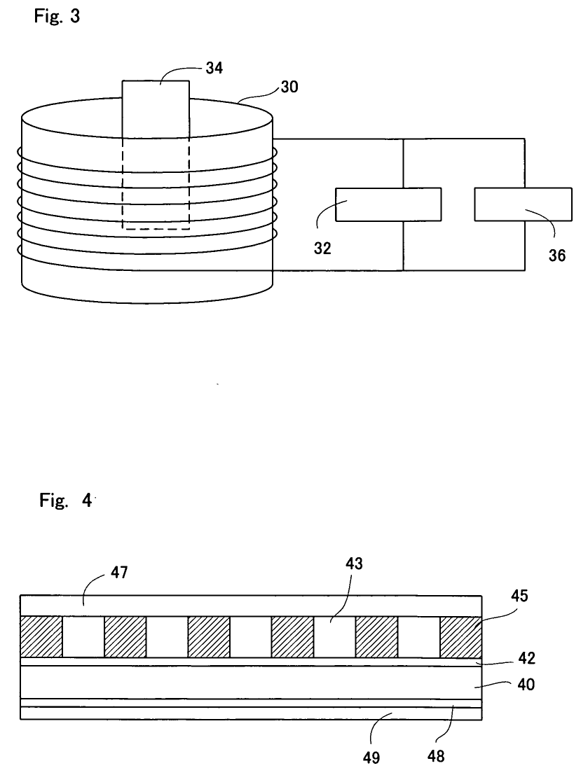

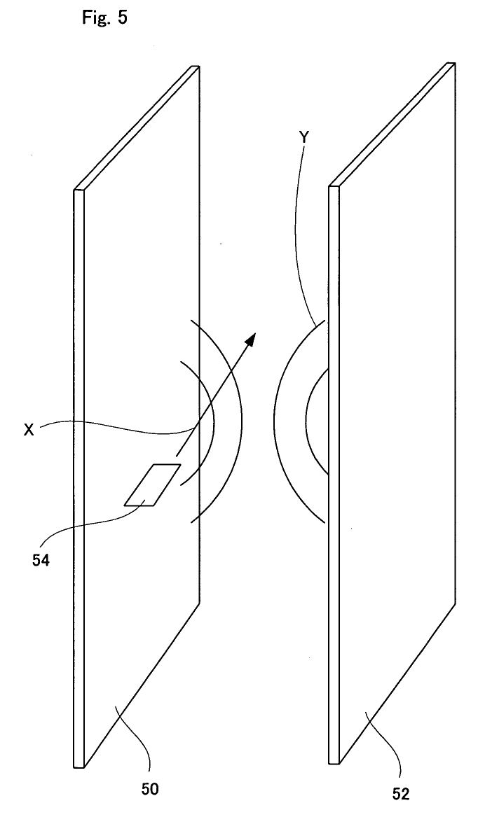

The magnetic property of each detection tag was measured using a magnetic property tester shown in FIG. 3. From the obtained magnetic property value of each magnetic detection tag, it was evaluated the capability of the reactivation machine.

In FIG. 3, 30 is a measurement coil and a conductor of 0.5 mm in diameter is wound round the surface of the cylindrical coil of 60 mm in diameter 180 times. The two ends of the conductor are connected to an AC power source 32. A sine wave power of 5 kHz (current: fixed at 0.5 A) is supplied from the AC power source 32 to the measurement coil 30. A response signal sent from a magnetic detection tag 34 inserted into the measurement coil 30 is detected by the measurement coil 30 and is sent to a voltage tester 36.

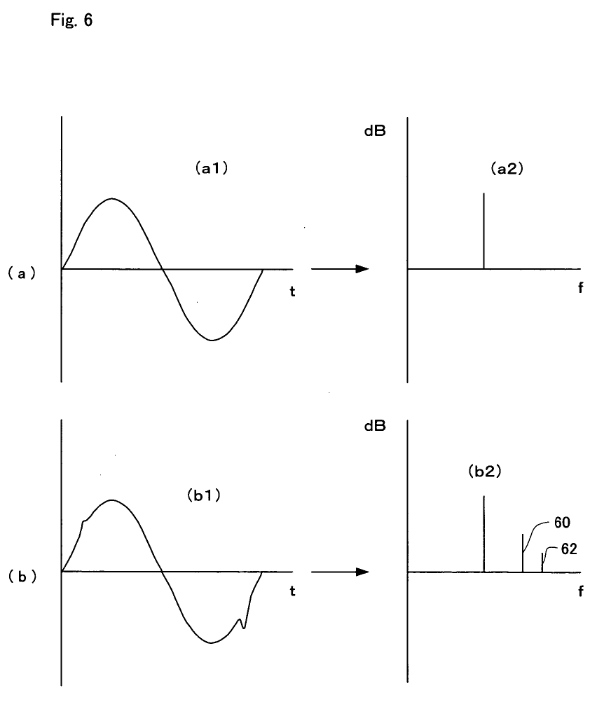

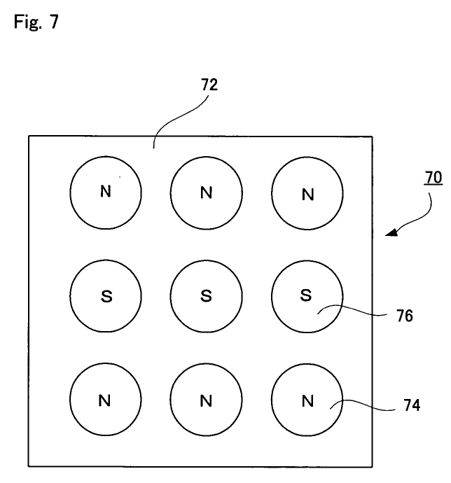

The principle of this measurement can be explained in the same manner as in the detection of a magnetic field distortion shown in FIG. 6. When the magnetic detection tag 34 is inserted into the measurement coil 30, an alternating magnetic field of distorted waveform corresponding to b1 of FIG. 6(b) is generated. A response signal caused by this distorted alternating magnetic field is detected by the measurement coil 30 and is sent to the voltage tester 36. In the voltage tester 36, this response signal is subjected to Fourier transform and the time axis is converted into a frequency axis. Then, there appears a higher harmonic [corresponding to 60 or 62 of FIG. 6(b)] caused by the distortion of alternating magnetic field.

In the present tester, a signal intensity of a higher harmonic of 10 kHz was measured and this was taken as magnetic property value. A higher magnetic property value indicates higher demagnetization.

Each of the above magnetic detection tags was subjected to deactivation (magnetization), reactivation (demagnetization) and measurement of magnetic property value for 5 times. The average of the obtained magnetic property values was calculated. In Table 1 are shown magnetic property value after deactivation and reactivation rate. The reactivation rate is a value obtained by dividing the magnetic property value after reactivation by the magnetic property value before deactivation.

Then, the 4 reactivated magnetic detection tags were passed in order through gates (trade name: EG-C 45, produced by LINTEC Corporation). All of the 4 magnetic detection tags were detected by the gates.

Comparative Reactivation Test 1

An operation was conducted in the same manner as in the above Reactivation Test 1 except that a commercial reactivation machine was used, whereby magnetic detection tags were reactivated. Their magnetic properties were measured. The results are shown in Table 1.

The reactivation machine used was a handy type (trade name: EL-R 01, produced by LINTEC Corporation). By moving this reactivation machine manually, magnetic detection tags were swept. In this reactivation machine, a permanent magnet array comprising a large number of permanent magnets arranged in parallel so that an N pole and a S pole appear alternately, is rotated by a battery-driven motor, whereby is generated an alternating magnetic field. Reactivation of magnetic detection tags was conducted by sweeping the magnetic detection tags in the thus-generated alternating magnetic field.

Next, the 4 magnetic detection tags were passed through the same gates as used in Reactivation Test 1, in order. None of the magnetic detection tags of Comparative Reactivation Test 1 was detected at the gates.

TABLE 1

| No. of | Magnetic | | | Comparative |
|---|---|---|---|---|
| magnetic | property | Reactivation Test 1 | | Reactivation Test |
| detection | value after | Reactivation rate (0.5 A) | | 1 |
| tag | deactivation | 500 Hz | 1 kHz | Reactivation rate |
| 1 | 0 | 0.67 | 0.99 | 0.21 |
| 2 | 0 | 0.69 | 0.93 | 0.34 |
| 3 | 0 | 0.77 | 1.03 | 0.23 |
| 4 | 0 | 0.76 | 1.00 | 0.33 |

As is clear from Table 1, when reactivation of magnetic detection tags was conducted using an alternating magnetic field of 500 Hz, the reactivation rates were 0.6 or more and all of the 4 magnetic detection tags were detected at the gates. It is clear from these results that the magnetic detection tags were reactivated sufficiently. That is, it is clear that, when the reactivation rate of magnetic detection tag is 0.6 or more, the magnetic detection tag is in a sufficiently reactivated state. It is also clear from Table 1 that a higher frequency gives a higher reactivation rate.

Reactivation Test 2

An operation was conducted in the same manner as in Reactivation Test 1. However, the AC power supplied to a coil to generate an alternating magnetic field was changed in a range from 0.3 A to 0.7 A. The frequency of the AC power was set at 1 kHz. The results are shown in Table 2.

Next, 4 magnetic detection tags were passed through the same gates as in Reactivation Test 1, in order. All of the 4 magnetic detection tags were detected at the gates.

TABLE 2

| | Magnetic | | | |
|---|---|---|---|---|
| No. of | property value | Reactivation Test 2 | | |
| magnetic | after | Reactivation rate (1 kHz) | | |
| detection tag | deactivation | 0.3 A | 0.5 A | 0.7 A |
| 1 | 0 | 0.97 | 0.99 | 1.00 |
| 2 | 0 | 0.77 | 0.94 | 0.88 |
| 3 | 0 | 0.90 | 1.03 | 1.05 |
| 4 | 0 | 0.85 | 1.00 | 0.98 |

As is clear from Table 2, when the current supplied to the coil was changed in a range from 0.3 A to 0.7 A, the reactivation rate was 0.6 or more in all cases.

Incidentally, in each of the above cases, there is a relation of Table 3 between the intensity of the alternating magnetic field generated in the gap P and the current value.

TABLE 3

| Current value A | 0.3 | 0.5 | 0.7 |
|---|---|---|---|
| Alternating magnetic field intensity T | 0.075 | 0.126 | 0.175 |

Reactivation Test 3 and Comparative Reactivation Test 2

Using the reactivation machine produced in Example 1, magnetic detection tags were reactivated by the same operation as in Reactivation Test 1. However, the sweeping speed of the reactivation machine was 1 m/s and the frequency of alternating magnetic field was 300 Hz, 500 Hz and 1 kHz.

As the magnetic detection tags, those used in Reactivation Test 1 were used per se. Incidentally, the intensity of alternating magnetic field was the same as that of Table 3 when the current value was 0.5 A.

Using the previously-mentioned commercial reactivation machine of handy type, Comparative Reactivation Test 2 was conducted in the same manner as in Comparative Reactivation Test 1. The sweeping speed of the reactivation machine was 1 m/s. The results are shown in Table 4.

Next, each of the above-reactivated magnetic detection tags was passed through the same gates as in Reactivation Test 1. All of each 4 magnetic detection tags used in Reactivation Test 3 and Comparative Reactivation Test 2 were detected at the gates.

TABLE 4

| | | | | | Comparative |
|---|---|---|---|---|---|
| No. of | Magnetic | | | | Reactivation |
| magnetic | property | Reactivation Test 3 | | | Test 2 |
| detection | value after | Reactivation rate (0.5 A) | | | Reactivation |
| tag | deactivation | 300 Hz | 500 Hz | 1 kHz | rate |
| 1 | 0 | 1.06 | 0.99 | 1.04 | 1.07 |
| 2 | 0 | 0.91 | 0.94 | 0.97 | 1.06 |
| 3 | 0 | 1.10 | 1.14 | 1.10 | 1.20 |
| 4 | 0 | 0.90 | 0.88 | 0.93 | 1.02 |

As is clear from Table 4, the reactivation rate of magnetic detection tag was 0.6 or more in all the cases of Reactivation Test 3 and Comparative Reactivation Test 2.

### Example 2

Reactivation machines were produced in the same manner as in Example 1 except that the width P of gap was changed to 0.5 mm or 2.0 mm.

Reactivation Test 4

Using the reactivation machines produced in Example 2, a reactivation test was conducted in the same manner as in Reactivation Test 1. However, the sweeping speed of the reactivation machines was 1 m/s. The magnetic detection tag used was the No. 3 of the magnetic detection tags shown in Table 1. The results are shown in Table 5.

Next, the magnetic detection tags after the reactivation test were passed trough the same gates as in Reactivation Test 1, in order. All of the magnetic detection tags were detected at the gates.

TABLE 5

| | Magnetic | | | | Intensity of |
|---|---|---|---|---|---|
| | property | Reactivation Test 4 | | | alternating |
| Width P | value after | Reactivation rate (0.5 A) | | | magnetic |
| of gap | deactivation | 300 Hz | 500 Hz | 1 kHz | field T |
| 0.5 | 0 | 0.86 | 0.95 | 0.94 | 0.252 |
| 2.0 | 0 | 0.70 | 0.85 | 0.83 | 0.063 |

As is clear from Table 5, the reactivation rate was 0.6 or more even when the width P of gap was changed to 0.5 mm or 2.0 mm.

### Example 3

Coils shown in FIG. 8 were produced. Each of two plates [26 mm×12 mm×1 mm (thickness)] made of a permeability material (78% Permalloy PC produced by OHTAMA Co., LTD.) was bent parallel to the length 26 mm side at the center of plate of the length 12 mm to produce core plates 84a and 84b. The external angle of each bent portion was 40°.

As shown in FIG. 8, a copper conductor of 0.27 mm in diameter was wound round a U-shaped ferrite core main body 82 shown in FIG. 10 (trade name: Ferrite Core UI-25-35, width s of each core end s=6 mm, thickness r=6 mm, distance l between two ends of U-shaped core=13 mm, produced by TOMITA ELECTRIC Co., LTD.), at the two arm portions each 357 times. The two ends of the conductor were connected in series.

Then, to the two ends of the U-shaped ferrite core main body 82 were adhered the above-mentioned core plates 84a and 84b with an adhesive (an instantaneous adhesive produced by Henkel Japan Ltd., trade name: LOCTITE 401). The gap constituted by the core plates 84a and 84b had a width P of 4 mm. Other constitutions were the same as in the constitution of Example 1, whereby a reactivation machine was produced.

Reactivation Test 5

A reactivation test was conducted in the same manner as in Reactivation Test 1. However, the current was 0.6 A (the intensity of the alternating magnetic field generated between the core plates 84a and 84b was 0.075 T); the sweeping speed of the reactivation machine was 1 m/s; during the sweeping, the distance between the surface of magnetic detection tag and the gap 85 of reactivation machine was maintained at 1 mm. The results are shown in Table 6.

Then, the reactivated magnetic detection tags were passed between the same gates as in Reactivation Test 1, in order. All of the magnetic detection tags were detected at the gates.

### Example 4

A reactivation machine similar to that of Example 3 was produced. However, three U-shaped ferrite core main bodies 82 were laminated in a total thickness of 3 r. Further, a conductor of 0.32 mm in diameter was wound round the core main body 82 at the two arm portions each 200 times, and the two ends of the conductor were connected in series.

Reactivation Test 6

A reactivation test was conducted in the same manner as in Reactivation Test 5. The results are shown in Table 6.

Then, the reactivated magnetic detection tags were passed between the same gates as in Reactivation Test 1, in order. All of the magnetic detection tags were detected at the gates.

TABLE 6

| | No. of | Magnetic | | | |
|---|---|---|---|---|---|
| | magnetic | property | | | |
| Reactivation | detection | value after | Reactivation rate (0.6 A) | | |
| Test | tag | deactivation | 300 Hz | 500 Hz | 1 kHz |
| 5 | 1 | 0 | — | 0.95 | — |
| | 2 | 0 | — | 0.97 | — |
| | 3 | 0 | — | 1.26 | — |
| | 4 | 0 | — | 1.03 | — |
| 6 | 1 | 0 | 1.07 | 1.00 | 1.00 |
| | 2 | 0 | 0.99 | 1.04 | 1.02 |
| | 3 | 0 | 1.02 | 0.98 | 1.02 |
| | 4 | 0 | 1.01 | 1.03 | 0.98 |

As is clear from Table 6, the reactivation rate of magnetic detection tag was 0.6 or more in all cases of Reactivation Test 5 and Reactivation Test 6.

1. A method for reactivating a magnetic detection tag, which comprises exposing a magnetic detection tag having a soft magnetic substance layer and a hard magnetic substance layer, to an alternating magnetic field generated by applying an AC power to a coil, moving, in this state, either or both of the magnetic detection tag and the alternating magnetic field, thereby sweeping the magnetic detection tag in the alternating magnetic field to demagnetize the magnetized hard magnetic substance layer of the magnetic detection tag.

2. The method for reactivating a magnetic detection tag according to claim 1, wherein the AC power has a frequency of 100 to 10,000 Hz.

3. The method for reactivating a magnetic detection tag according to claim 1, wherein the alternating magnetic field has an intensity of 0.01 T or more.

4. The method for reactivating a magnetic detection tag according to claim 1, wherein the magnetic detection tag is swept in the alternating magnetic field at a speed of 5 m/s or less.

5. A machine for reactivating a magnetic detection tag having a soft magnetic substance layer and a hard magnetic substance layer, which comprises an AC power source and a coil which is connected to the AC power source and generates an alternating magnetic field when an AC power is supplied from the AC power source.

6. The machine for reactivating a magnetic detection tag according to claim 5, wherein the coil comprises a core made of a cylindrical dielectric, having at least one gap parallel to the axial direction of core and a conductor wound on the core surface along the section of core parallel to the axial direction of core.

7. The machine for reactivating a magnetic detection tag according to claim 5, wherein the coil comprises
a core formed by folding a dielectric at its middle portion of lengthwise direction so that the two ends of dielectric face each other, forming, at the two ends, projections apart from each other by a given distance and projecting in a direction opposite from the middle portion, thereby forming a gap between the projections, and
a conductor wound on the core surface in the width direction of core.

8. The machine for reactivating a magnetic detection tag according to claim 6, wherein the gap has a width of 0.1 to 20 mm.

9. The machine for reactivating a magnetic detection tag according to claim 6, wherein the AC power has a frequency of 100 to 10,000 Hz.

10. The machine for reactivating a magnetic detection tag according to claim 7, wherein the gap has a width of 0.1 to 20 mm.

11. The machine for reactivating a magnetic detection tag according to claim 7, wherein the AC power has a frequency of 100 to 10,000 Hz.
